(19) United States
(12) Patent Application Publication
(10) Pub. No.: US 2025/0095019 A1
(43) Pub. Date: Mar. 20, 2025

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventor: Hiroshi Shimada, Tokyo (JP)

(73) Assignee: NEC Corporation, Minato-ku, Tokyo (JP)

(21) Appl. No.: 18/727,435

(22) PCT Filed: Jan. 5, 2023
(86) PCT No.: PCT/JP2023/000058

§ 371 Date: Jul. 9, 2024

(30) Foreign Application Priority Data
Jan. 24, 2022 (JP) 2022-008409

(51) Int. Cl. G06Q 30/0226; G06Q 20/40

(52) U.S. Cl. CPC G06Q 30/0233; G06Q 20/40145

(57) ABSTRACT

This information processing device comprises: one or more memories storing instructions; and one or more processors configured to execute the instructions to: acquire identification information relating to the user; identify a point service available in a store; and identify member information relating to the available point service identified, from among member information relating to point services associated with the identification information.

### TECHNICAL FIELD

The present disclosure relates to a method of utilizing a plurality of point services, and the like.

### BACKGROUND ART

PTL 1 discloses a point service integrating system in which a plurality of pieces of point service member information are registered in such a way that a customer can utilize a point service. In PTL 1, a point service integration system receives company information of a company to which a store belongs and customer identification information of a customer from a point of sales (POS) terminal of the store. The point service integration system collates the received company information with the company information registered in the system, and grants the point of the point service provided by the collated company information to the customer.

### CITATION LIST

### Patent Literature

PTL 1: JP 2003 044934 A

### SUMMARY OF INVENTION

### Technical Problem

However, in the point service integration system described in PTL 1, the customer cannot utilize the point service other than the company to which the store belongs in the store.

On the other hand, currently, as the point service that can be used in one store, not only the point service provided by the company to which the store belongs but also the point service provided by another company can be utilized in many cases. Therefore, it is desirable that the user can easily utilize a plurality of point services.

An object of the present disclosure is to provide a technique that allows a user to easily utilize a plurality of point services.

### Solution to Problem

An information processing device according to one aspect of the present disclosure includes an acquiring means for acquiring identification information of a user; a service identifying means for identifying a point service available in a store; and a member information identifying means for identifying member information of the available point service identified by the service identifying means among member information of point services associated with the identification information.

An information processing system according to one aspect of the present disclosure includes an acquiring means for acquiring identification information of a user; a service identifying means for identifying a point service available in a store; and a member information identifying means for identifying member information of the available point service identified by the service identifying means among member information of point services associated with the identification information.

An information processing method according to one aspect of the present disclosure includes acquiring identification information of a user; identifying a point service available in a store; and identifying member information of the identified point service available in the store among member information of the point services associated with the identification information.

An information processing program according to one aspect of the present disclosure causes a computer to execute an acquiring process of acquiring identification information of a user; a service identifying process of identifying a point service available in a store; and a member information identifying process of identifying the member information of the available point service identified in the service identifying process among the member information of the point services associated with the identification information. The information processing program may be stored in a computer-readable non-transitory recording medium.

### Advantageous Effects of Invention

An example of an effect of the present disclosure is that a user can easily utilize a plurality of point services.

### BRIEF DESCRIPTION OF DRAWINGS

FIG. 1 is a block diagram illustrating a configuration of an information processing device according to a first example embodiment.

FIG. 2 is a flowchart illustrating an operation of the information processing device according to the first example embodiment.

FIG. 3 is a block diagram illustrating a configuration of an information processing device according to a second example embodiment.

FIG. 4 is a flowchart illustrating an operation of the information processing device according to the second example embodiment.

FIG. 5 is a block diagram illustrating a configuration of an information processing device according to a third example embodiment.

FIG. 6 is a flowchart illustrating an operation of the information processing device according to the third example embodiment.

FIG. 7 is a block diagram illustrating a configuration of an information processing system according to a modified example.

FIG. 8 is a block diagram illustrating a configuration of an information processing system according to a modified example.

FIG. 9 is a block diagram illustrating a configuration of an information processing system according to a modified example.

FIG. 10 is a diagram illustrating a hardware configuration in which the information processing device according to the present disclosure is implemented by a computer device and its peripheral devices.

### EXAMPLE EMBODIMENT

Example embodiments of the present disclosure will be described in detail with reference to the drawings.

In the following example embodiment, the user is a user who utilizes the point service at the time of shopping. Furthermore, the store is a store where the user shops. The store is not limited to a real store.

### First Example Embodiment

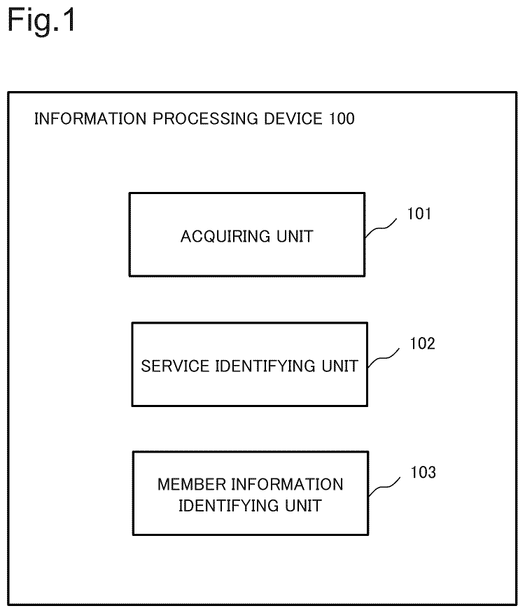

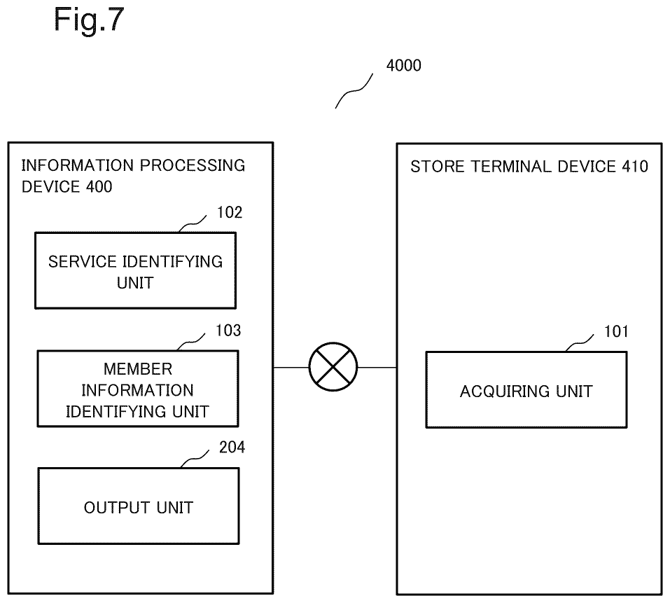

FIG. 1 is a block diagram illustrating a configuration of an information processing device 100 according to a first example embodiment. Referring to FIG. 1, the information processing device 100 includes an acquiring unit 101, a service identifying unit 102, and a member information identifying unit 103. Furthermore, the information processing device 100 described below may be implemented as an information processing system. An example of the information processing system will be described later as a modified example illustrated in FIGS. 7 to 9.

Next, a configuration of the information processing device 100 according to the first example embodiment will be described in detail.

In FIG. 1, the acquiring unit 101 is an example of an acquiring means for acquiring identification information of a user. The identification information of the user is information that can uniquely specify or identify the user. The identification information of the user is, for example, an identification number, a barcode, a two-dimensional barcode, or biometric authentication information. The identification information of the user is not limited thereto. The acquiring unit 101 acquires the identification information of the user by various means according to the type of the identification information. Furthermore, the acquiring unit 101 may acquire the identification information from a device connected to the processor or an information processing device communicably connected via a network.

The service identifying unit 102 is an example of a service identifying means for identifying the point service available in the store. The service identifying unit identifies a point service available in the store, for example, by searching a storage unit (not illustrated). Specifically, the storage unit (not illustrated) stores the store information and the available point service in association with each other. The store information is, for example, identification information of a terminal of the store. In this case, for example, the available point service is stored in association with the identification information of the terminal of the acquiring source store from which the acquiring unit 101 has acquired the identification information. Then, the service identifying unit 102 identifies the point service available in the acquiring source store stored in association with the identification information of the terminal of the acquiring source store. Alternatively, the store information may be identification information indicating the store separately acquired by the acquiring unit 101. In this case, for example, the service identifying unit 102 identifies the point service available in the store stored in association with the identification information indicating the store. The point service identified by the service identifying unit 102 and available in the store may be one or more.

The member information identifying unit 103 is an example of a member information identifying means for identifying the member information of the available point service identified by the service identifying unit 102 among the member information of the point service associated with the identification information. The member information of the point service is, for example, information for identifying each member given to each member in various point services. For example, the member information is a member identification number. The member identification number is a number for identifying a member of the point service. The member identification number includes a number displayed as a barcode in a point card or an application for saving points.

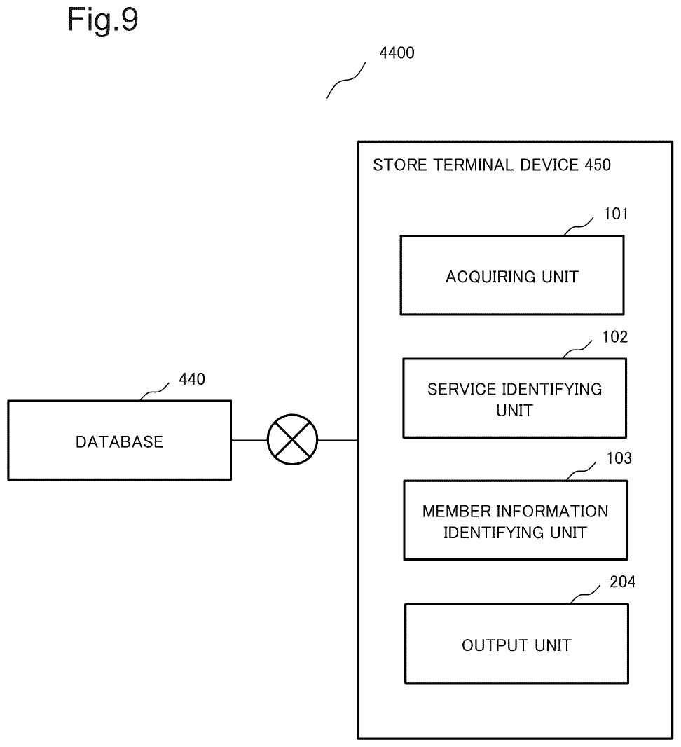

The storage unit (not illustrated) is an example of a storage means for storing the identification information of the user, the information for identifying the point service, and the member information of the user of the point service in association with each other. The storage unit (not illustrated) may store the information for identifying the plurality of point services and the member identification number of the user of each of the plurality of point services in association with the identification information of the user. The information for identifying the point service and the member identification number of the user are registered in advance in the storage unit by the operation of the user. The storage unit may be a storage device 13 of a computer device 10 illustrated in FIG. 9 to be described later. Specifically, the information for identifying the point service and the member identification number of the user of the point service may be registered in the storage device 13 from the input/output interface (I/F) 14 in advance via the input device, or may be registered in the storage device 13 from the terminal device of the user via the communication interface (I/F) 15.

The information for identifying the point service is, for example, a name of the point service or a number for identifying the point service. The member information identifying unit 103 identifies the member information of the point service identified by the service identifying unit 102 among the member information of the point service associated with the identification information of the user acquired by the acquiring unit 101. In addition, it is assumed that there are a plurality of pieces of member information of the point service associated with the identification information of the user acquired by the acquiring unit 101, and there are a plurality of point services identified by the service identifying unit 102 among the plurality of pieces of member information. In this case, the member information identifying unit 103 identifies a plurality of pieces of member information corresponding to each of the plurality of identified point services.

As a result, for example, the user can utilize one or a plurality of point services without holding the point card in shopping in the store.

The storage unit (not illustrated) is not limited to the storage unit inside the information processing device 100. The storage unit (not illustrated) may be outside the information processing device 100. For example, the storage unit and the information processing device 100 may be communicably connected. The storage unit referred to by the service identifying unit 102 and the storage unit referred to by the member information identifying unit 103 may be one device or may exist by being divided into a plurality of devices.

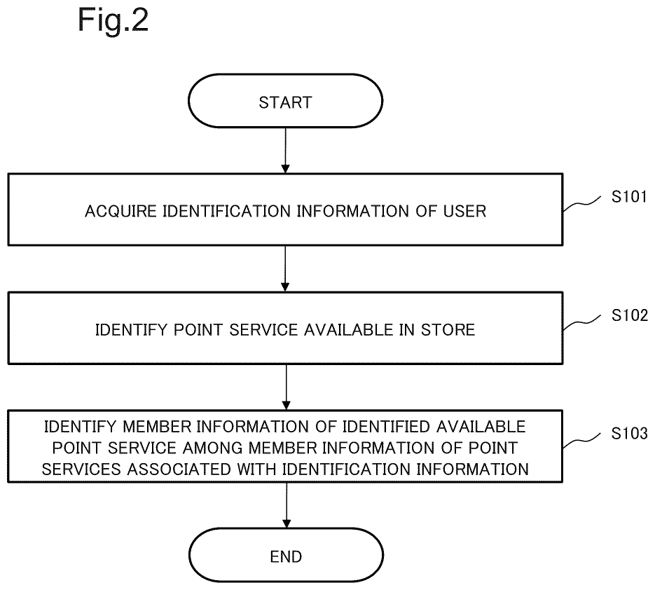

The operation of the information processing device 100 configured as described above will be described with reference to the flowchart of FIG. 2.

FIG. 2 is a flowchart illustrating an outline of an operation of the information processing device 100 according to the first example embodiment. The processes according to this flowchart may be executed based on a program control by the processor.

As illustrated in FIG. 2, first, the acquiring unit 101 acquires identification information of a user (step S101).

Next, the service identifying unit 102 identifies a point service available in the store (step S102).

Next, the member information identifying unit 103 identifies the member information of the available point service identified in step S102 among the member information of the point service associated with the identification information of the user (step S103).

Thus, the information processing device 100 ends the series of operations.

In the information processing device according to the present example embodiment described above, the acquiring unit acquires the identification information of the user. Then, the service identifying unit identifies a point service available in the store. Then, the member information identifying unit identifies the member information of the available point service identified by the service identifying unit among the member information of the point service associated with the identification information.

As a result, the user can easily utilize a plurality of point services by the information processing device according to the present example embodiment. For example, the user does not need to identify, on his/her own, the point service available in the store among the plurality of point services registered by the user.

### Second Example Embodiment

Next, a second example embodiment of the present disclosure will be described in detail with reference to the drawings. Hereinafter, description of contents overlapping with the above description will be omitted to the extent that the description of the present example embodiment is not unclear.

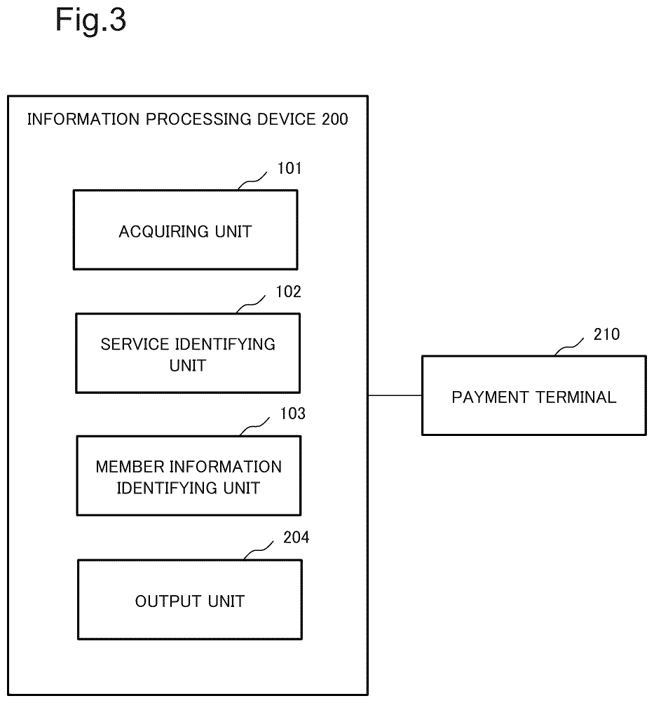

FIG. 3 is a block diagram illustrating a configuration of an information processing device 200 according to a second example embodiment of the present disclosure. The information processing device 200 of the second example embodiment includes an output unit 204 in addition to the configuration of the first example embodiment. Furthermore, the information processing device 200 is communicably connected to the payment terminal 210. Alternatively, the information processing device 200 may be included in the payment terminal 210.

The output unit 204 is an example of an output means for outputting the member information identified by the member information identifying unit 103 to the payment terminal 210 that makes the payment in the store. Furthermore, in a case where the information processing device 200 is included in the payment terminal 210, the output unit 204 may output the member information identified by the member information identifying unit 103 to the payment processing unit for performing the payment process in the payment terminal 210.

The output unit 204 outputs the member identification number of the point service to the payment terminal 210 as, for example, the member information identified by the member information identifying unit 103. The payment terminal 210 performs a predetermined process relating to the point service on the member identification number input from the output unit 204. The predetermined process relating to the point service is, for example, transmitting the member identification number and the accounting information of the member to the point service company. In this manner, by outputting the member identification number to the payment terminal 210, the information processing device 200 can reduce the trouble required for inputting the member identification number such as causing the store clerk and the user to read the barcode including the member identification number.

In addition, the member information output by the output unit 204 is not limited to the member identification number. For example, the output unit 204 may output a barcode or a two-dimensional code including the member identification number as the member information.

The payment terminal 210 is a terminal that performs a payment process for the user's shopping, that is, a settlement process in the store. The payment terminal 210 is, for example, a POS terminal.

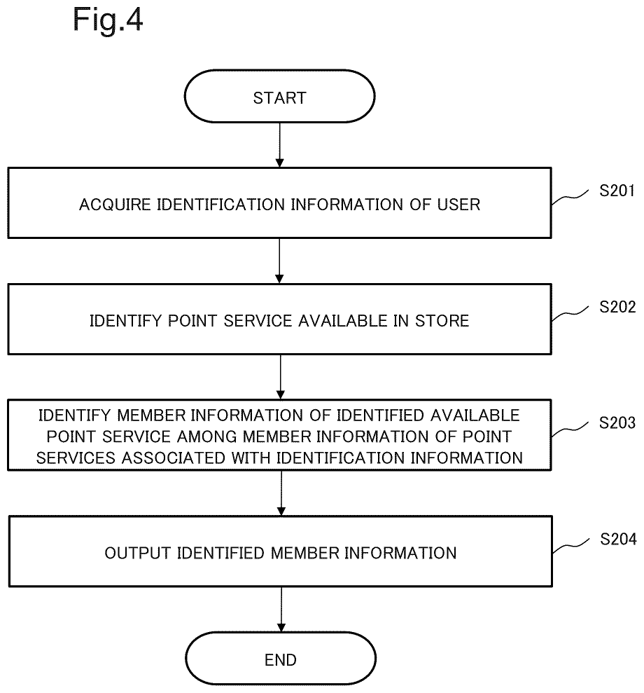

The operation of the information processing device 200 configured as described above will be described with reference to the flowchart of FIG. 4.

FIG. 4 is a flowchart illustrating an outline of an operation of the information processing device 200 according to the second example embodiment. The processes according to this flowchart may be executed based on a program control by the processor.

As illustrated in FIG. 4, first, the acquiring unit 101 acquires identification information of a user (step S201).

Next, the service identifying unit 102 identifies a point service available in the store (step S202).

Next, the member information identifying unit 103 identifies the member information of the available point service identified in step S102 among the member information of the point service associated with the identification information of the user (step S203).

Next, the output unit 204 outputs the member information identified in step S203 to the payment terminal 210 that makes a payment in the store (Step S204). The payment terminal 210 to which the member information is output in step S204 executes a process of point granting or point utilization of the point service utilized by the user. Here, the point granting and the point utilization may be point addition and point subtraction, respectively. For example, when the member identification number of the point service of the user is output as the member information in step S204, the payment terminal 210 executes a process for notifying the point card company of the number of points to be added to the received member identification number. Furthermore, in a case where the point service is a point service unique to the store or the company to which the store belongs, the payment terminal 210 may execute a process of adding a point to the received member identification number.

Thus, the information processing device 200 ends the series of operations.

The acquiring unit in the present example embodiment described above acquires the identification information of the user. The service identifying unit identifies a point service available in the store. The member information identifying unit identifies the member information of the available point service identified by the service identifying unit among the member information of the point service associated with the identification information. Then, the output unit outputs the member information identified by the member information identifying unit 103 to the payment terminal that makes the payment in the store.

As a result, the information processing device according to the present example embodiment allows the user to easily utilize a plurality of point services. In particular, in the information processing device of the present example embodiment, the output unit outputs the member information to the payment terminal of the store, in such a way that the trouble of the user and the store clerk can be reduced when the user utilizes the point service.

### Third Example Embodiment

Next, a third example embodiment of the present disclosure will be described in detail with reference to the drawings. Hereinafter, description of contents overlapping with the above description will be omitted to the extent that the description of the present example embodiment is not unclear.

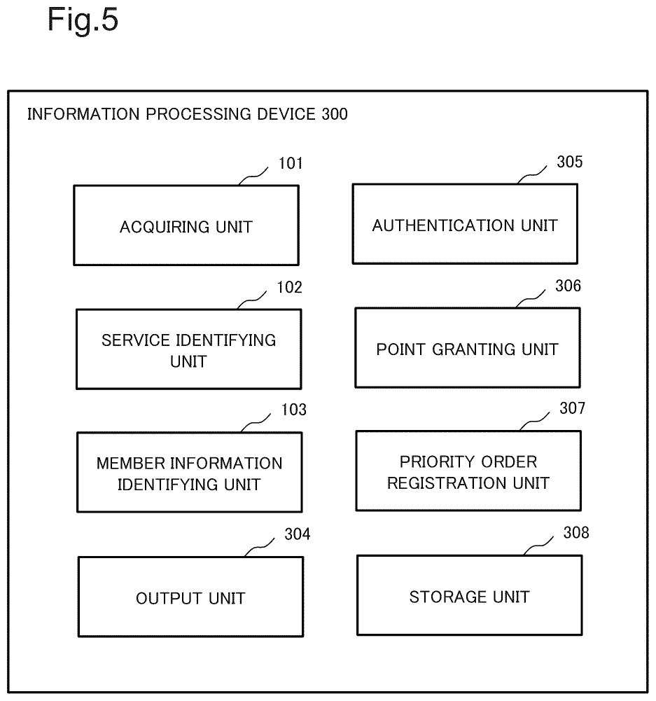

FIG. 5 is a block diagram illustrating a configuration of an information processing device 300 according to a third example embodiment of the present disclosure. The information processing device 300 of the third example embodiment includes an output unit 304 instead of the output unit 204 of the second example embodiment. The output unit 304 is an example of an output means. In addition, the information processing device 300 of the third example embodiment includes an authentication unit 305, a point granting unit 306, a priority order registration unit 307, and a storage unit 308 in addition to the configuration of the second example embodiment.

The authentication unit 305 is an example of an authentication means for authenticating the user using the biometric authentication information acquired as the identification information by the acquiring unit 101. Alternatively, the acquiring unit 101 may acquire the biometric authentication information, and after the authentication of the authentication unit 305 described below, the acquiring unit 101 may acquire the identification information stored in association with the biometric authentication information. The biometric authentication includes various biometric authentications, such as face authentication, iris authentication, or fingerprint authentication. In particular, in a case where the authentication unit 305 uses the face authentication or the iris authentication as the biometric authentication, the information processing device 300 includes the authentication unit 305, in such a way that the user can utilize the service more easily. Furthermore, in this case, the user can utilize the service without contact, that is, hygienically.

In a case where the authentication unit 305 performs face authentication, for example, the acquiring unit 101 acquires a face image from the imaging device. The imaging device is, for example, a camera of a store. The acquiring unit 101 may acquire the face image from the image photographed by the imaging device. Then, the authentication unit 305 performs authentication based on the face image. Alternatively, the acquiring unit 101 may acquire information extracted from the face image or information obtained by processing the face image. The authentication unit 305 performs authentication on the basis of the information acquired by the acquiring unit 101.

In a case where the authentication unit 305 is provided, the output unit 304 may output information indicating whether the authentication is successful to the terminal of the user or the terminal of the store. Furthermore, when the authentication fails, the output unit 304 may output information for selecting whether to perform the biometric authentication again in addition to the information indicating that the authentication has failed. Alternatively, when the authentication fails, the output unit 304 may output an instruction to the acquiring unit to acquire the biometric authentication information again in addition to the output indicating that the authentication has failed.

The point granting unit 306 is an example of a point granting means for granting a point to the member information of the flagged point service among the point services identified by the service identifying unit 102 based on the accounting information. The member information of the flagged point service may not be output to the payment terminal 210 for point granting unlike other point services. The member information of the flagged point service may be output to the payment terminal 210 in such a way that the user or the store clerk can confirm whether the member information is correct. Furthermore, regarding the flagged point service, the output unit 304 may further output information relating to the member information. The information relating to the member information may include, for example, the number of points to be granted, the number of points to be used, an expiration date of the points, campaign information relating to the points, and the like.

For example, the point granting unit 306 determines the point according to the accounting amount of money included in the accounting information. Then, the point granting unit 306 adds the determined point to the number of points associated with the member information. The flag set for the point service indicates, for example, that the point service is a point service that is available in the store and is specific to the store, that is, unique to the store. The point service specific to the store is, for example, a point service of a company to which the store belongs. The flag is stored in the storage unit 308 in association with the point service specific to the store. Since the information processing device 300 includes the point granting unit 306, a business operator utilizing the information processing device 300 can provide unique point services.

In a case where the information processing device 300 includes the point granting unit 306, the acquiring unit 101 further acquires accounting information in the store of the user. The accounting information is information for determining a point to be granted to the accounting of the user in the store. The accounting information is, for example, the amount of money purchased and the number of points granted. In addition, the accounting information may include information indicating the purchased item and the number.

An example of a process in which the point granting unit 306 grants a point will be described. For example, the point granting unit 306 calculates the number of points to be granted to the user based on the accounting information. Next, the point granting unit 306 adds the calculated number of points to the number of points associated with the storage unit 308, thereby granting points.

In addition, in a case where the user utilizes the point of the flagged point service, the point granting unit 306 may perform a process for subtracting the point. For example, the point granting unit 306 performs a process of utilizing points by subtracting the number of points to be utilized acquired by the acquiring unit 101 from the number of points associated with the storage unit 308.

In a case where the point granting unit 306 is provided, the output unit 304 may output the current number of points of the user to the terminal of the user or the terminal of the store. Furthermore, the output unit 304 may further output the number of points added or subtracted.

The priority order registration unit 307 is an example of a priority order registration means for registering the priority order of the point service associated with the identification information of the user. For example, the priority order registration unit 307 registers the priority order in association with the point service or the member information of the point service.

An example of a specific process of the priority order registration unit 307 will be described. The priority order registration unit 307 accepts an input of the priority order of each point service from the user. Then, the priority order registration unit 307 registers the input priority order of the point service in the storage unit 308.

Alternatively, the priority order registration unit 307 may register the priority order of the point service stored in association with the identification information of the user with a predetermined specified value. For example, the specified value may have the highest priority order of the flagged point service.

In general, in shopping in a store, a general-purpose point service can be utilized in addition to the point service of the company to which the store belongs. In addition, the general-purpose point service may utilize one type determined in advance for the company to which the store belongs, but the general-purpose point service may utilize at least one type selected by the user from a plurality of types determined in advance for the company to which the store belongs. Alternatively, the user may select and utilize a point service of a company to which the store belongs or a general-purpose point service. As described above, in general, the user selects a point service from a plurality of point services including a general-purpose point service. In the present example embodiment, since the priority order is registered by the priority order registration unit 307, the user does not need to select the point service in the store. That is, since the information processing device 300 includes the priority order registration unit 307, the user can more easily utilize the plurality of point services without the user selecting, every time, the point service to utilize from the plurality of point services in the store. The general-purpose point service is a service in which the user can utilize the point service in shopping of a plurality of companies operating the store. The general-purpose point service or the point service of the company to which the store belongs may include the point service of the facility to which the store belongs.

Similarly to the storage unit (not illustrated) described in the first example embodiment, the storage unit 308 is an example of a storage means for storing the identification information of the user and the member information of the point service in association with each other. Furthermore, the storage unit 308 stores the information on the store and the information on the point service available in the store in association with each other. In addition, as described in the third example embodiment, the storage unit 308 may store biometric authentication information for performing biometric authentication of the user, the number of points of a flagged point service, and priority order information of each point service in association with identification information of the user. Furthermore, the storage unit 308 may further store the point history information of the flagged point service, the shopping history information, and the like in association with the identification information of the user. In addition, the storage unit 308 may store information indicating whether each point service can be used together with another point service. Alternatively, the storage unit 308 may store information indicating whether each point service can be used with another point service in association with the information on the point service available in the store.

The storage unit 308 may not be one physical configuration. The storage unit 308 may be communicably connected to the inside or the outside.

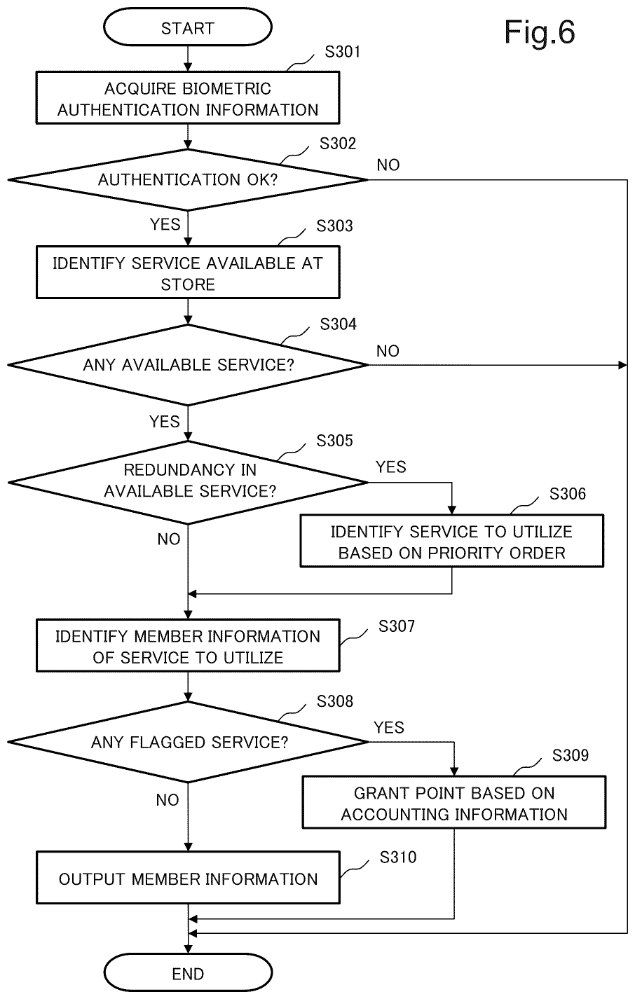

The operation of the information processing device 300 configured as described above will be described with reference to the flowchart of FIG. 6.

FIG. 6 is a flowchart illustrating an outline of an operation of the information processing device 300 according to the third example embodiment. The processes according to this flowchart may be executed based on a program control by the processor.

As illustrated in FIG. 6, first, the acquiring unit 101 acquires biometric authentication information (step S301).

Next, the authentication unit 305 performs biometric authentication using the biometric authentication information acquired in step S301 (step S302). In a case of NO in step S302, that is, in a case where the biometric authentication has failed, the information processing device 300 ends the operation.

If a case of YES in step S302, that is, if the biometric authentication is successful, the service identifying unit 102 identifies a point service available in the store (step S303). Specifically, the service identifying unit 102 identifies the point service by searching the storage unit 308 that stores the information on the store and the information on the point service available in the store in association with each other.

Next, the member information identifying unit 103 determines whether there is a point service stored in the storage unit 308 in association with the user among the point services available in the store (step S304). Specifically, the member information identifying unit 103 performs the determination of step S304 by searching the storage unit 308 storing the identification information of the user and the member information of the point service of the user in association with each other. More specifically, the member information identifying unit 103 searches for the point service available in the store identified in step S303 from among the point services stored in association with the biometrically authenticated user. In a case of NO in step S304, that is, in a case where the point service available in the store is not stored in association with the user, the information processing device 300 ends the operation. Alternatively, in a case of NO in step S304, the output unit 304 may output information urging registration to the point service.

In a case of YES in step S304, that is, in a case where the point service available in the store has been stored in association with the user, whether there is a point service that cannot be overlappingly utilized is determined (step S305). For example, in a case where there is one point service stored in association with the user among the point services available in the store, the determination in step S305 is NO. Furthermore, for example, in a case where there are two point services stored in association with the user among the point services available in the store, and the user can utilize the two point services in combination in the store, the determination in step S305 is NO. Alternatively, for example, in a case where there are a plurality of point services stored in association with the user among the point services available in the store, and the user cannot utilize any combination thereof, the determination in step S305 is YES.

In a case of NO in step S305, in a case where there is no overlap in the available point services, the service identifying unit 102 identifies the point service to be utilized by the user in the store as the point service available in the store. Then, the process of the information processing device 300 proceeds to step S307.

In a case of YES in step S305, that is, in a case where there is overlapping in the available point services, the service identifying unit 102 identifies the point service to be utilized by the user in the store based on the priority order stored in the storage unit 308 (step S306). For example, in a case where the available point services are overlapping, the service identifying unit 102 identifies a point service that is associated with the available point service and has a higher priority order as the point service to be utilized by the user in the store. In addition, in a case where there are point services that can be utilized in combination, the service identifying unit 102 may identify the point service having the next highest priority order among the point services that can be used in combination with the point service having the higher priority order identified earlier as the point service to be utilized in combination by the user in the store.

Next, the member information identifying unit 103 identifies the member information of the point service to be utilized by the user in the store identified in step S305 or step S306 (step S307).

Next, the point granting unit 306 determines whether the flagged point service is included in the point service to be utilized by the user in the store identified in step S305 or step S306 (step S308).

In a case of YES in step S308, that is, in a case where the point service to be utilized by the user in the store includes the flagged point service, the point granting unit 306 grants a point based on the accounting information (step S309). The accounting information may be acquired simultaneously with the biometric authentication information in step S301. Alternatively, the accounting information may be acquired when determined YES in step S308. The timing of acquiring the accounting information is not limited.

In a case of NO in step S308, that is, in a case where there is an unflagged point service in the point service to be utilized by the user in the store, the output unit 304 outputs the member information of the point service to the payment terminal (step S310). The payment terminal may be, for example, the payment terminal 210 illustrated in FIG. 3.

The information processing device 300 then ends the series of operations.

In a case where determination is made in step S308 that there are both the flagged point service and the unflagged point service, both processes of step S309 for the flagged point service and step S310 for the unflagged point service may be performed.

In the information processing device according to the present example embodiment described above, the acquiring unit acquires the biometric authentication information as the identification information of the user. The authentication unit performs biometric authentication based on the acquired biometric authentication information. The service identifying unit identifies a point service available in the store. The member information identifying unit identifies the member information of the available point service identified by the service identifying unit among the member information of the point service associated with the identification information. Then, the output unit outputs the member information to the payment terminal that makes a payment in the store. When there is the flagged point service, the point granting unit grants a point to the member information of the flagged point service based on the accounting information. In addition, the priority order registration unit registers the priority order of the point service associated with the identification information in the storage unit.

As a result, the information processing device according to the present example embodiment allows the user to easily utilize a plurality of point services.

### First Modified Example

The information processing device 300 described in the third example embodiment can be changed to include at least one of the authentication unit 305, the point granting unit 306, or the priority order registration unit 307. For example, the information processing device 100 according to the first example embodiment or the information processing device 200 according to the second example embodiment may be changed to an information processing device including one or two of the authentication unit 305, the point granting unit 306, or the priority order registration unit 307.

Furthermore, each of the information processing devices described in the first to third example embodiments and the above-described variously changed information processing device may be implemented as an information processing system. The information processing system includes, for example, a server or a cloud computing system and a store terminal device. Furthermore, the information processing system may include a POS terminal. FIGS. 7 to 9 illustrate a part of an example of an information processing system which is a modified example of the information processing device 200 in the second example embodiment.

The information processing system 4000 in FIG. 7 includes an information processing device 400 and a store terminal device 410. The information processing device 400 includes a service identifying unit 102, a member information identifying unit 103, and an output unit 204. The information processing device 400 is achieved as, for example, a server or a cloud computing system. The store terminal device 410 includes an acquiring unit 101. For example, the acquiring unit 101 acquires the identification information of the user from the imaging device of the store. The acquiring unit 101 may include an image processing device that extracts a face image or face authentication information from an image captured by the imaging device. The output unit 204 of the information processing device 400 outputs the member information to the payment terminal that makes a payment in the store. Alternatively, the member information may be output to a payment terminal that makes a payment in a store connected to the store terminal device 410 via the store terminal device 410.

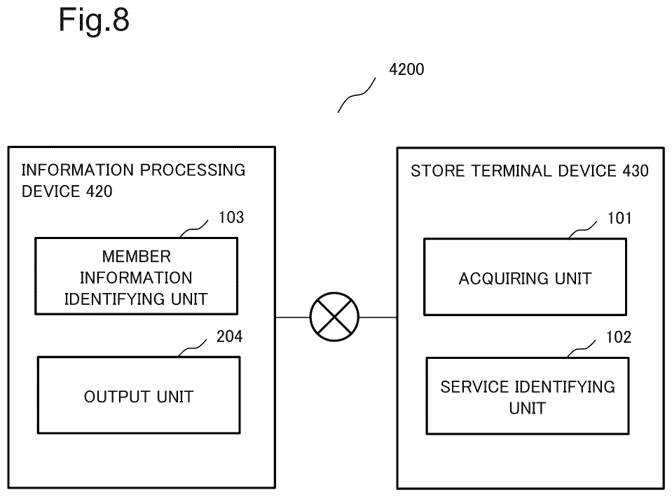

The information processing system 4200 in FIG. 8 includes an information processing device 420 and a store terminal device 430. The information processing device 420 includes a member information identifying unit 103 and an output unit 204. The information processing device 420 is achieved as, for example, a server or a cloud computing system. The store terminal device 410 includes an acquiring unit 101 and a service identifying unit 102.

The information processing system 4400 in FIG. 9 includes a database 440 and a store terminal device 450. The database 440 functions as a storage unit (not illustrated) in the first and second example embodiments or a storage unit 308 in the third example embodiment. The database 440 is achieved by a server or cloud computing. The store terminal device 450 includes an acquiring unit 101, a service identifying unit 102, a member information identifying unit 103, and an output unit 204.

As described above, each information processing device described in each example embodiment and the above-described variously changed information processing device may be achieved as an information processing system.

### Second Modified Example

The information processing device and the information processing system according to each example embodiment and each modified example of the present disclosure may identify a service and identify member information for a payment service as well in addition to the point service. The payment service is, for example, credit card payment, code payment using a bar code or a two-dimensional code, or payment utilizing electronic money. The payment service is not limited thereto.

In this case, the service identifying unit 102 further identifies a payment service available in the store. The member information identifying unit 103 identifies the member information of the payment service associated with the identification information of the user acquired by the acquiring unit 101 among the payment service identified by the service identifying unit 102.

With such a configuration, the user can more easily utilize the plurality of services also in the payment service by each information processing device and each information processing system of the present disclosure.

### [Hardware Configuration]

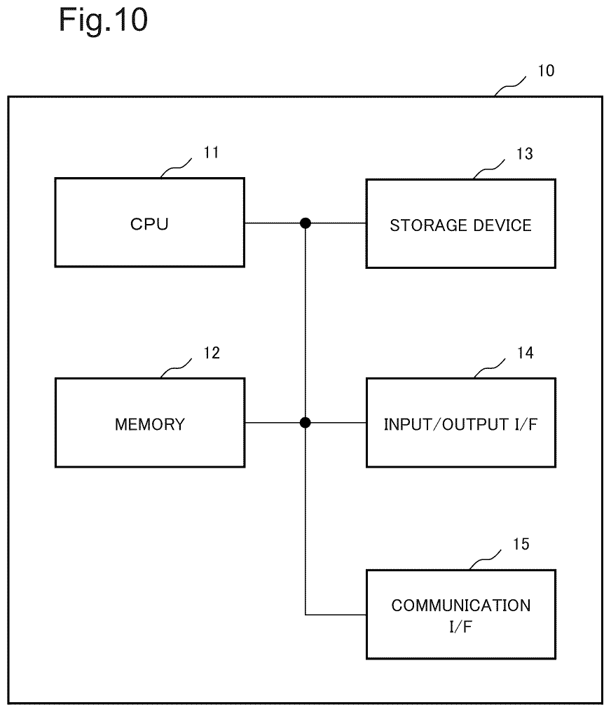

Each component in each example embodiment of the present disclosure described above is represented by a functional block, and as with the computer device illustrated in FIG. 10, the function can be achieved not only by hardware but also by a computer device or firmware based on program control.

FIG. 10 is a diagram illustrating an example of a hardware configuration in which each device in each example embodiment of the present disclosure is achieved by a computer device 10 including a processor. As illustrated in FIG. 10, the computer device 10 includes a central processing unit (CPU) 11, a memory 12, a storage device 13 such as a hard disk that stores a program, an input/output interface (I/F) 14 for connecting an input device and an output device, and a communication interface (I/F) 15 for connecting a network.

The CPU 11 operates the operating system to control the entire devices of the present disclosure. In addition, the CPU 11 reads a program and data from a storage medium attached to, for example, a drive device or the like to the memory 12. In addition, the CPU 11 executes processes or instructions based on a program, for example, as a part of each configuration in the example embodiment.

The storage device 13 is, for example, an optical disk, a flexible disk, a magnetic optical disk, an external hard disk, a semiconductor memory, or the like. A storage medium of a part of the storage device is a non-volatile storage device, and a program is recorded therein. Furthermore, the program may be downloaded from an external computer (not illustrated) connected to a communication network.

An input device connected to the input/output interface (I/F) 14 is used for input operation. For example, the input device is achieved by a mouse, a keyboard, a key button connected to the inside or the outside, or the like. The input device is not limited to a mouse, a keyboard, and a key button. For example, the input device may be a touch panel.

Similarly, an output device connected to the input/output interface (I/F) 14 is used to confirm an output. For example, the output device is achieved by a display or a speaker.

The communication interface (I/F) 15 performs wired communication or wireless communication with another device.

As described above, each device of each example embodiment of the present disclosure is implemented by computer hardware illustrated in FIG. 10. However, the means for achieving each unit included in each device is not limited to the configuration described above. Furthermore, each device may be achieved by one physically coupled device. Alternatively, each device may be achieved by a plurality of devices in which two or more physically separated devices are connected in such a way as to be able to communicate in a wired or wireless manner. For example, the input device and the output device may be connected to the computer device 10 via a network.

Although the present invention has been described with reference to the respective example embodiments, the present invention is not limited to the above example embodiments. Various modifications that can be understood by those skilled in the art can be made to the configuration and details of the present invention within the scope of the present invention.

In addition, although the plurality of operations are described in order in the form of a flowchart, the order of description does not limit the order of executing the plurality of operations. Therefore, when each example embodiment is implemented, the order of the plurality of operations may be changed within a range that does not interfere in content.

This application is based upon and claims the benefit of priority from Japanese Patent Application No. 2022-008409, filed on Jan. 24, 2022, the disclosure of which is incorporated herein in its entirety by reference.

Some or all of the above example embodiments may be described as the following supplementary notes, but are not limited to the following.

### (Supplementary Note 1)

An information processing device including:
an acquiring means for acquiring identification information of a user;
a service identifying means for identifying a point service available in a store; and
a member information identifying means for identifying member information of the available point service identified by the service identifying means among member information of point services associated with the identification information.

### (Supplementary Note 2)

The information processing device according to Supplementary Note 1, further including
an output means for outputting the member information identified by the member information identifying means to a payment terminal that makes payment in the store.

### (Supplementary Note 3)

The information processing device according to Supplementary Note 2, wherein
the output means outputs member identification number of the point service as the member information identified by the member information identifying means.

### (Supplementary Note 4)

The information processing device according to any one of Supplementary Notes 1 to 3, wherein
the identification information is biometric authentication information, and
the information processing device further includes an authentication means for performing authentication of the user using the biometric authentication information acquired by the acquiring means.

### (Supplementary Note 5)

The information processing device according to any one of Supplementary Notes 1 to 4, wherein
the acquiring means acquires accounting information of the user in the store, and
the information processing device further includes a point granting means for granting a point based on the accounting information with respect to member information of a flagged point service among the point services identified by the service identifying means.

### (Supplementary Note 6)

The information processing device according to any one of Supplementary Notes 1 to 5, further including
a priority order registration means for registering a priority order of a point service associated with the identification information, wherein
in a case where there are a plurality of point services available in the store, the service identifying means identifies a service to be utilized by the user based on the priority order.

### (Supplementary Note 7)

The information processing device according to any one of Supplementary Notes 1 to 6, wherein
the service identifying means further identifies a payment service available in the store, and
the member information identifying means identifies member information of a payment service associated with the identification information.

### (Supplementary Note 8)

The information processing device according to any one of Supplementary Notes 1 to 7, further including
a storage means for storing the identification information and member information of a plurality of services in association with each other.

### (Supplementary Note 9)

An information processing system including:
an acquiring means for acquiring identification information of a user;
a service identifying means for identifying a point service available in a store; and
a member information identifying means for identifying member information of the available point service identified by the service identifying means among member information of point services associated with the identification information.

### (Supplementary Note 10)

An information processing method including:
acquiring identification information of a user;
identifying a point service available in a store; and
identifying member information of the identified point service available in the store among member information of the point services associated with the identification information.

### (Supplementary Note 11)

A recording medium storing an information processing program for causing a computer to execute:
an acquiring process of acquiring identification information of a user;
a service identifying process of identifying a point service available in a store; and
a member information identifying process of identifying the member information of the available point service identified in the service identifying process among the member information of the point services associated with the identification information.

### REFERENCE SIGNS LIST

10 computer
11 CPU
12 memory
13 storage device
14 input/output I/F
15 communication I/F
100 information processing device
101 acquiring unit
102 service identifying unit
103 member information identifying unit
200 information processing device
204 output unit
210 payment terminal
300 information processing device
304 output unit
305 authentication unit
306 point granting unit
307 priority order registration unit
308 storage unit
400 information processing device
410 store terminal device
420 information processing device
430 store terminal device
440 database
450 store terminal device
4000 information processing system
4200 information processing system
4400 information processing system

What is claimed is:

1. An information processing device comprising:
one or more memories storing instructions; and
one or more processors configured to execute the instructions to:
acquire identification information of a user;
identify a point service available in a store; and
identify member information of the available point service identified among member information of point services associated with the identification information.

2. The information processing device according to claim 1, wherein the one or more processors configured to execute the instructions to:
output the member information identified to a payment terminal that makes payment in the store.

3. The information processing device according to claim 2, wherein the one or more processors configured to execute the instructions to:
output member identification number of the point service as the member information identified.

4. The information processing device according to claim 1, wherein
the identification information is biometric authentication information, and
wherein the one or more processors configured to execute the instructions to:
perform authentication of the user using the biometric authentication information acquired.

5. The information processing device according to claim 1, wherein the one or more processors configured to execute the instructions to:
acquire accounting information of the user in the store, and
grant a point based on the accounting information with respect to member information of a flagged point service among the point services identified.

6. The information processing device according to claim 1, wherein the one or more processors configured to execute the instructions to:
register a priority order of a point service associated with the identification information; and
in a case where there are a plurality of point services available in the store, identify a service to be utilized by the user based on the priority order.

7. The information processing device according to claim 1, wherein the one or more processors configured to execute the instructions to:
identify a payment service available in the store, and
identify member information of a payment service associated with the identification information.

8. The information processing device according to claim 1, wherein the one or more memories store:
the identification information and member information of a plurality of services in association with each other.

9. (canceled)

10. An information processing method comprising:
acquiring identification information of a user;
identifying a point service available in a store; and
identifying member information of the identified point service available in the store among member information of the point services associated with the identification information.

11. A non-transitory computer-readable recording medium storing an information processing program for causing a computer to execute:
an acquiring process of acquiring identification information of a user;
a service identifying process of identifying a point service available in a store; and
a member information identifying process of identifying the member information of the available point service identified in the service identifying process among the member information of the point services associated with the identification information.
